(19) United States
(12) Patent Application Publication
(10) Pub. No.: US 2012/0151537 A1
(43) Pub. Date: Jun. 14, 2012

(54) METHOD AND SYSTEM FOR ASYNCHRONOUS AND ISOCHRONOUS DATA TRANSMISSION IN A HIGH SPEED VIDEO NETWORK

(75) Inventors: Harkirat Singh, San Jose, CA (US); Ilju Na, Suwon (KR); Jae Min Lee, Suwon (KR); Chiu Ngo, San Francisco, CA (US)

(73) Assignee: SAMSUNG ELECTRONICS CO., LTD., Suwon (KR)

(21) Appl. No.: 13/308,412

(22) Filed: Nov. 30, 2011

Related U.S. Application Data
(60) Provisional application No. 61/423,024, filed on Dec. 14, 2010.

(51) Int. Cl. H04N 21/00

(52) U.S. Cl. 725/81

(57) ABSTRACT

A method and system for communication between audio/video (AV) devices. In one embodiment communication between AV devices includes establishing an AV path stream for AV data streaming between a source AV device and a destination AV device, wherein each AV device includes one or more I/O ports for connecting the AV device to another AV device via a communication link including multiple communication lanes. Asynchronous and isochronous AV data is multiplexed for transmission via one or more fixed length data cells, each data cell capable of carrying one or more of: an asynchronous data symbol and an isochronous data symbol. Multiplexing includes selectively mapping asynchronous data onto isochronous symbols for transmission during a video blanking period. One or more data cells are transmitted from a physical layer of the source AV device to the destination AV device, via one or more communication lanes.

### CROSS REFERENCE TO RELATED APPLICATIONS

This application claims the benefit of U.S. Provisional Patent Application Ser. No. 61/423,024, filed on Dec. 14, 2010, incorporated herein by reference.

### FIELD OF THE INVENTION

The present invention relates in general to video transmission, and in particular, to isochronous video stream management in a high speed audio/video network.

### BACKGROUND OF THE INVENTION

Increasing multimedia content, and specially high quality multimedia content, presents a number of communication and processing challenges to designers and administrators of computing platforms and networks alike. A number of standards have been developed for transporting high quality multimedia data. For example, DisplayPort (DP) standard and Digital Interactive Interface for Video and Audio (DiiVA) support high quality multimedia data transportation. In such standards, however, it is not possible to transmit auxiliary data over a main video channel.

### BRIEF SUMMARY OF THE INVENTION

The present invention relates to data communication between audio/video (AV) devices. In one embodiment, communication between AV devices includes establishing an AV path stream for AV data streaming between a source AV device and a destination AV device, wherein each AV device includes one or more I/O ports for connecting the AV device to another AV device via a communication link including multiple communication lanes. Asynchronous and isochronous AV data is multiplexed for transmission via one or more fixed length data cells, each data cell capable of carrying one or more of: an asynchronous data symbol and an isochronous data symbol. Multiplexing includes selectively mapping asynchronous data onto isochronous symbols for transmission during a video blanking period. One or more data cells are transmitted from a physical layer of the source AV device to the destination AV device, via one or more communication lanes.

These and other features, aspects and advantages of the present invention will become understood with reference to the following description, appended claims and accompanying figures.

### BRIEF DESCRIPTION OF THE DRAWINGS

FIG. 1A shows a block diagram of a network of AV devices including a source audio/video (AV) device and a destination AV device, implementing data stream management for audio/video data communication, according to an embodiment of the invention.

FIG. 1B shows a block diagram of an implementation of the network of AV devices in FIG. 1A, according to an embodiment of the invention.

FIG. 1C shows a block diagram of a switched network of AV devices including a source AV device, one or more bridge AV devices and a destination AV device, implementing data stream management for audio/video data communication, according to an embodiment of the invention.

FIGS. 2A-2B show allocation of communication channel time for isochronous data stream management for audio/video data communication, according to an embodiment of the invention.

FIG. 2C shows a block diagram of an AV device for audio/video data communication, according to an embodiment of the invention.

FIG. 3 shows an example video frame for transmission between an AV source device and AV sink device, according to an embodiment of the invention.

FIG. 4A shows a process for AV data multiplexing communication between AV devices, according to an embodiment of the invention.

FIG. 4B shows another process for AV data multiplexing communication between AV devices, according to an embodiment of the invention.

FIG. 5 shows an example process wherein asynchronous data is extended over the isochronous characters currently carrying the video blanking data, according to an embodiment of the invention.

FIG. 6A shows a communication process at an AV source device, according to an embodiment of the invention.

FIG. 6B shows a communication process at an AV sink device, according to an embodiment of the invention.

FIG. 7 shows an example audio packet for transmission between an AV source device and AV sink device, according to an embodiment of the invention.

FIG. 8 is a high level block diagram showing an information processing system comprising a computer system useful for implementing an embodiment of the invention.

### DESCRIPTION OF THE INVENTION

Embodiments of the invention relate to transmission of asynchronous and isochronous data in a high speed video network. In one embodiment the invention provides asynchronous data transmission during reserved isochronous characters when the reserved characters do not carry any useful audio/video (AV) data during video blanking periods. Embodiments of the invention allow selectively mapping asynchronous data over reserved isochronous characters.

Video data transmission occurs during a reserved isochronous period. The isochronous period includes active video pixel period in addition to video blanking periods. As asynchronous data is multiplexed with isochronous data on the same lane, embodiments of the invention use the blanking periods for selectively transmitting useful data such as asynchronous data.

In one embodiment of the invention, a physical communication medium/link between two physical devices (such as a source device and a sink device in a video network) is represented as a continuous flow of N-character long units (i.e., Rubicles), wherein certain characters are reserved for carrying video data (i.e., isochronous characters). When no active video is transmitted during a video blanking period, the reserved but free isochronous characters are used to transmit asynchronous data.

Asynchronous data during isochronous blanking periods can be transmitted between two devices which are different from the devices that have reserved the isochronous characters. Any intermediate device on a communication path from the source device to the sink device can use these free isochronous characters.

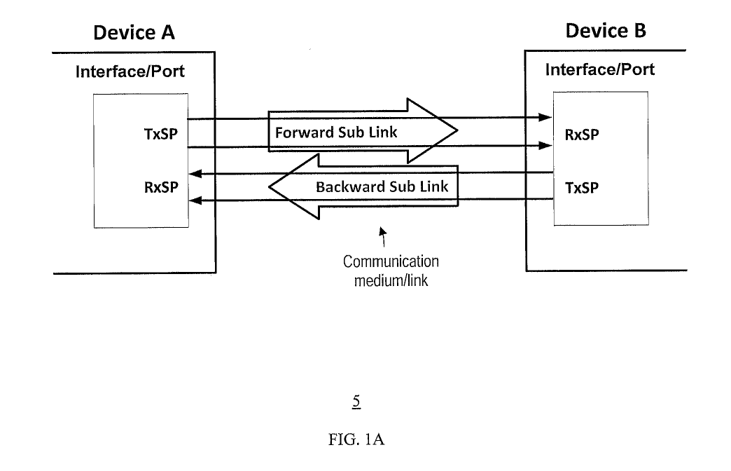

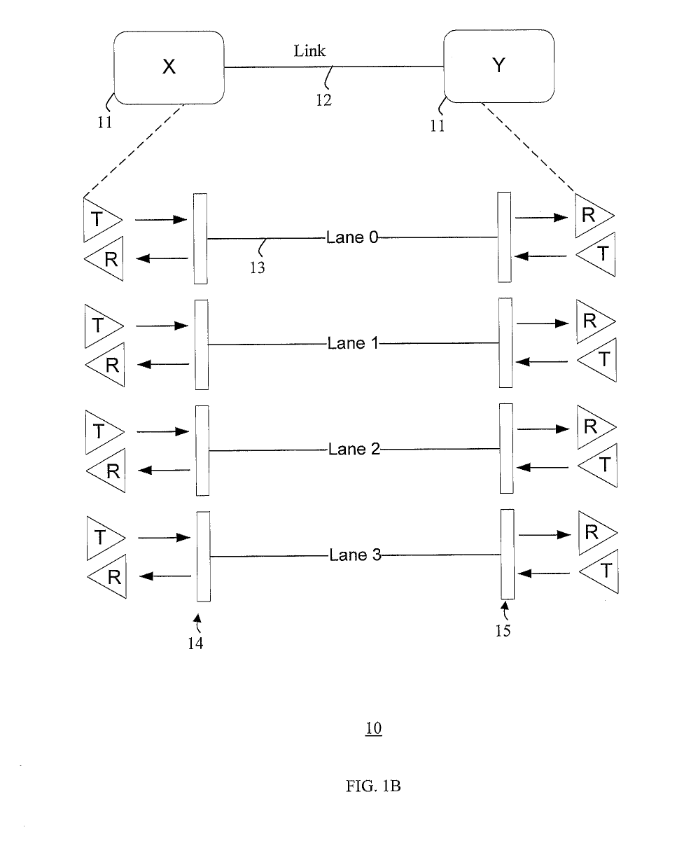

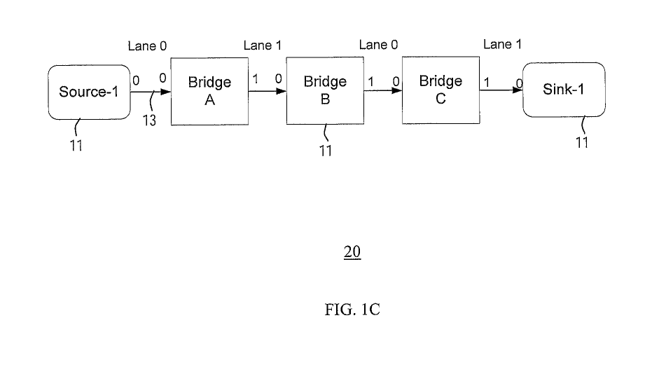

FIG. 1A shows a block diagram of an AV network 5, according to an embodiment of the invention, including linked devices Device A and Device B, wherein each device implements a high-speed multimedia interface. Each device may have multiple such interfaces or ports (e.g., I/O ports). Each port may comprise, for example, one or more twisted pairs (electrical conductors) or lanes in a communication link. In one embodiment, the number of lanes per port may vary from 2 to 6. In another embodiment, the number of lanes may be more than six.

According to embodiments of the invention, each said interface may provide a physical connection in between devices to enable bi-directional communication of multimedia traffic (e.g., compressed or uncompressed AV data), management data and bulk data traffic. As shown in FIG. 1A, four physical lanes are available on a port from a first device (e.g., Device A) to a second device (e.g., Device B). Two lanes are configured in transmit mode (TxSP: Transmitter Subport) forming a forward sub link. The other two lanes are configured in the reverse mode (RxSP: Receiver Subport) forming a backward sub link.

FIG. 1B shows a block diagram of a wired AV network 10 comprising AV devices 11 (i.e., device X and device Y) connected via a wired communication link 12, according to an embodiment of the invention. The network 10 in FIG. 1B is an example implementation of the network 5 in FIG. 1A. As is shown in FIG. 1B, the link 12 includes four physical lanes 13 (i.e., Lane 0, . . . , Lane 3) available on a port 14 of device X to a port 15 of device Y. In one example, each lane 13 can be configured either in Transmit (T) mode or in Receive (R) mode. In another example, each lane 13 may be in the T or R mode per packet basis, involving frequent mode changes of the physical (PHY) layer of each device. In one example, device X may be a RUBI transmitter device (source) and device Y may be a RUBI receiver device (sink). Each of the devices X, Y includes processing hardware (e.g., CPU), AV processing applications, communication hardware, storage, memory and logic configured according to embodiments of the invention.

### Bi-Directional Uncompressed Video and Audio Streaming

In one embodiment of the invention, the network 10 comprises a switched network that provide bi-directional transmission of uncompressed video and audio data between a source device 11 (e.g., a DVD player) and a sink device 11 (e.g., display monitor), across a communication link. In one embodiment of the invention, each lane 13 may support 5 Gbps, and therefore a total of 20 Gbps over the four lanes 13. In another embodiment, more than four lanes 13 are supported on a port. In another embodiment, in order to provide bi-directional communication, at most 15 Gbps can be supported in one direction, thus leaving one lane for the reverse direction traffic.

Embodiments of the invention provide bi-directional support for AV streaming such that two out of total four lanes 13 are dynamically configured in a Transmit mode and the other two lanes are configured in a Receive mode, such that simultaneous transmission of audio and video becomes feasible.

In one embodiment of the invention, both video and audio data from a source device may pass through other devices on a communication link between the source and sink device, before reaching a sink device. For example, in a multi-hop scenario such as illustrated by a switched network 20 of serially connected AV devices 11 shown in FIG. 1C, there may be one or more switched AV bridge devices 11 connected to the source and sink AV devices 11, wherein both video and audio data from a source device pass through the bridge devices 11 before reaching the sink device.

Video data can have a pixel size of, for example, 18, 24, 30, 36 or 48 bits. At a minimum, video resolution will support resolutions from VGA (640x480) to 1080p (1920x1080) depending on capabilities of a display device at the sink device.

### Bulk Data Transfer:

In one embodiment of the invention, the lanes 13 used for transferring AV information may also be used for transferring large data files from the source device X to the sink device Y (e.g., destination device). This is achieved by multiplexing AV, control, and data over the lanes 13. For bulk data, serial bus (USB) or Ethernet data packets can be sent directly through the lanes 13. When USB or Ethernet protocol is not available, an application can send data as a generic data packet as well.

### Management and Control Data Transfer

According to an embodiment of the invention, AV data transmission involves end-to-end resource allocation (e.g., ports, lanes, communication link channel time) between a source device and a sink device. For example, in FIG. 1C, Source-1 to Sink-1 video data transmission requires allocation of ports, lanes, and channel time. The various ports and lanes may be dynamically configured, such that the resource allocation enables configuration of lanes in terms of T and R modes described above. Moreover, the channel time on a lane may be multiplexed among multiple streams. In this way, the channel time on each lane can be shared among multiple streams.

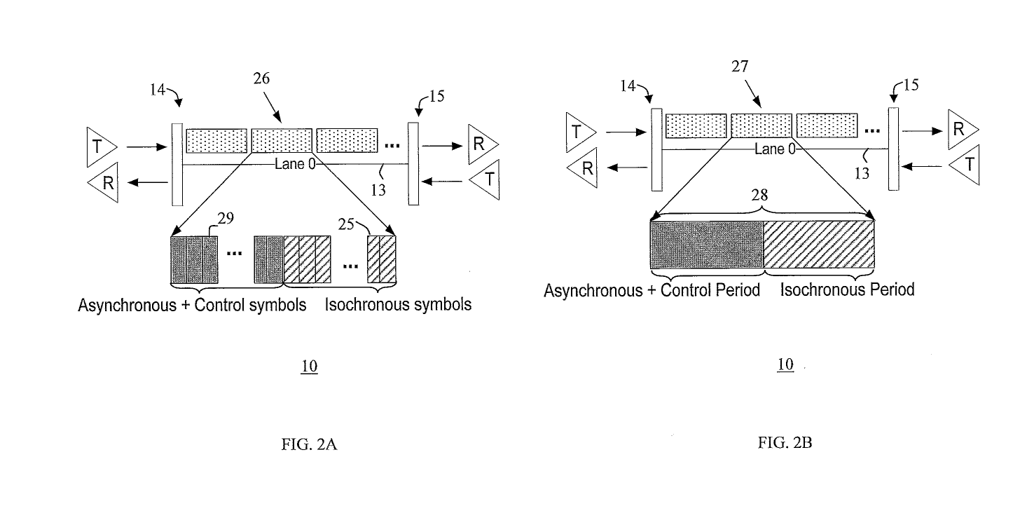

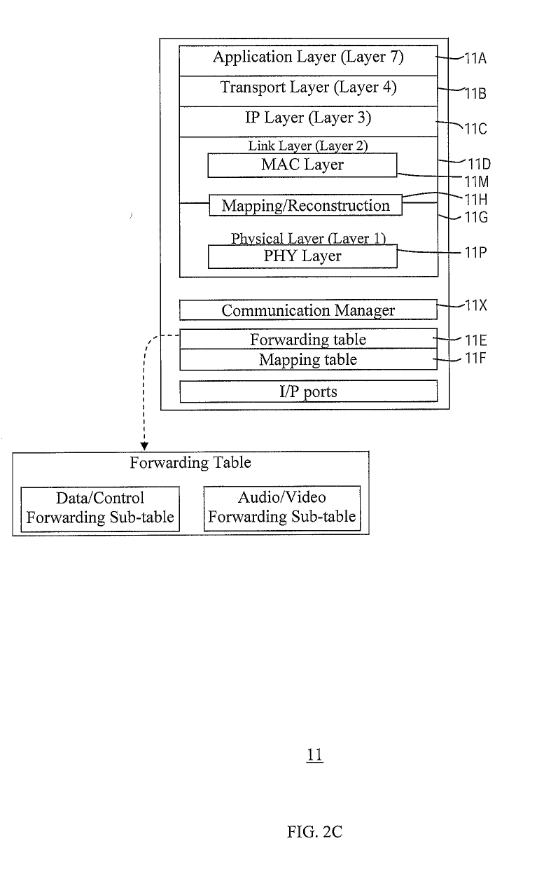

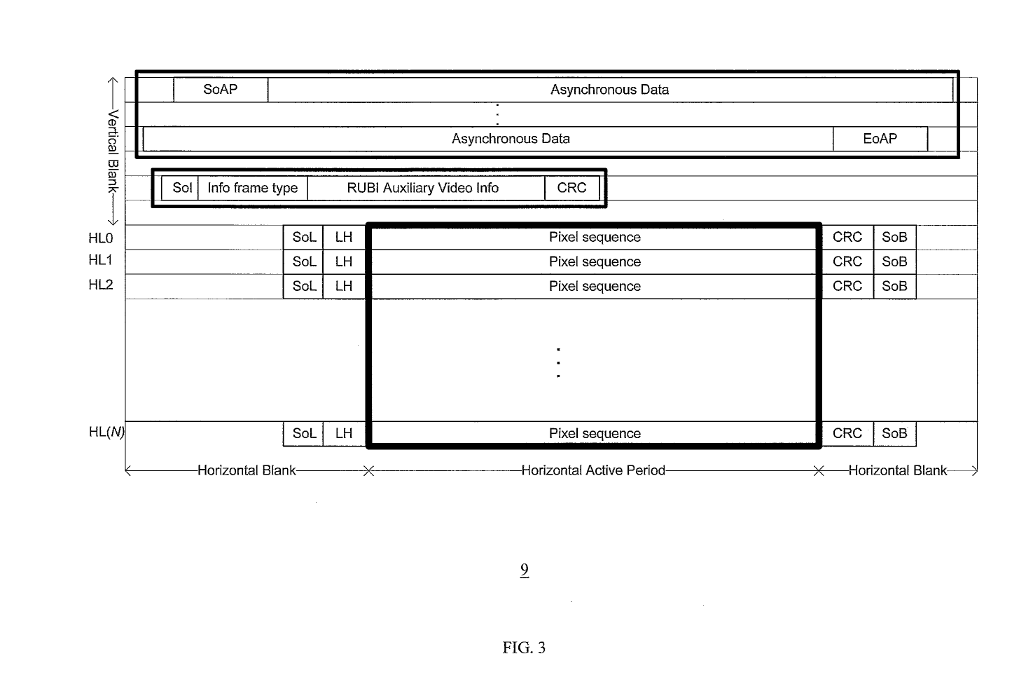

Referring to FIG. 2A, according to an embodiment of the invention, channel time may be divided into units for transmission of multiple fixed length packets. In such a case, channel time is allocated in terms of asynchronous control symbols 29, and isochronous symbols 25 within such fixed length packets 26 (e.g., transport packets), for isochronous channel time. FIG. 2A shows the case of channel time for isochronous streams in terms of symbols 25 within a transport packet.

According to an embodiment of the invention, channel time may be represented as a contiguous contention free period 28 on the channel, as shown by example in FIG. 2B, illustrating isochronous channel time allocation. FIG. 2B shows superframe based time allocation, wherein each superframe 27 that occurs on a periodic basis, includes contention free periods 28. Each period 28 comprises an asynchronous control period and an isochronous period. Only activity on Lane 0 is illustrated in FIGS. 2A-2B, however, other lanes existing on a port may follow the same implementation.

According to an embodiment of the invention, in an AV network the source device 11 (e.g., Source-1) is preferred to initiate a video path setup request (control message) as it has accurate information about the bandwidth requirement of an isochronous stream. The video path setup request includes a stream or sequence number to distinguish different video path setup requests generated by the source device. In one embodiment, the stream or sequence number may be maintained as a 16-bit or 32-bit counter in the source device such that each new video path setup request initiated by the source device has a different value.

Each AV device 11 in the video network maintains the stream index that can be represented as a combination of {Source address, Destination address, media access control (MAC) address of the device initiating the video-path-setup request, and stream number or sequence number}, wherein MAC comprises medium access control information. Based on these values, each AV device 11 can distinguish between different stream indices. The stream index is a local variable in each AV device that is not shared with other AV devices in the AV network. According to an embodiment of the invention, a mapping table 11F (FIG. 2C) may be used for maintaining the stream index, as shown by example Table 1 below.

TABLE 1
Mapping Table

| | Isochronous Stream Details (from the control message) | | | |
|---|---|---|---|---|
| | | | | Sequence |
| | | Des- | MAC address of the | number or |
| Stream | Source | tination | device initiated the | stream |
| Index | Address | Address | video_path_setup_Request | number |
| a | X | Y | X | n |
| b | U | R | R | k |
| . . . | . . . | . . . | . . . | . . . |

Further, as shown by the example Table 2 below, a mapping table for an AV device (i.e., devices 11 in FIG. 1C) may have entries based on Source-1 initiating a video-path-setup request and setting the sequence or stream number field set to S.

TABLE 2
Mapping Table

| | Isochronous Stream Details (from the control message) | | | |
|---|---|---|---|---|
| | | | | Sequence |
| | | Des- | MAC address of the | number or |
| Stream | Source | tination | device initiated the | stream |
| Index | Address | Address | video_path_setup_Request | number |
| 0 | Source-1 | Sink-1 | Source-1 | S |

Referring to FIG. 2C, one embodiment of an AV device (e.g., AV devices 11) comprises an Application Layer (Layer 7) 11A including processes that use the network, a Transport or TCP Layer (Layer 4) 11B including processes that provide end-to-end data delivery, an IP Layer or Network/Internet Layer (Layer 3) 11C including processes handling routing of data, a Link Layer (Layer 2) 11D and a Physical Layer (Layer 1) 11G for accessing physical communication medium. These layers are similar to TCP/IP layers which can be loosely mapped to the Open System Architecture (OSI). The Link Layer includes a MAC Layer 11M and the Physical Layer includes a PHY Layer 11P, configured for communication over an AV wired network, according to embodiments of the invention. Further, a communication manager 11x including a multiplexing module, implements multiplexing for data communication between AV devices the AV network.

In an AV path stream setup process, according to an embodiment of the invention, isochronous video stream connection setup begins when a stream controller device 11A transmits an Initiate connection control message that may be transmitted (e.g., over Layer 4 (FIG. 2C)). Upon receiving the Initiate connection control message, a source device in turn sends a Video path setup request control message to a sink device. Video path setup related control messages include various fields such as: {source address, destination address, Sequence number/stream number, Request Bandwidth Request, Time To Live (TTL), etc.}. The sink device sends a Video path setup response control message to the source device. The response indicates if the video path setup request is successful and the reason if the video path setup request failed. The controller device accesses a data/control forwarding sub-table (FIG. 2C) to determine forwarding information for the control message. The source device sends an Initiate connection confirmation control message to the controller device.

Once a video stream is established, a video forwarding sub-table is accessed for switching and forwarding of uncompressed video data. Each AV device can appropriately forward received video data on a corresponding port and lane to its downstream device. In one embodiment, the uncompressed video frames do not contain source and destination addresses such that the received video data is correctly forwarded on the downstream port based on the video forwarding sub-table. The video forwarding sub-table entries remain valid until a video-path setup control message with the matching sequence number is received to delete the allocation.

The controller device terminates the connection by sending a Terminate connection control message on Layer 4 (FIG. 2C), that is followed by a Layer 3 (FIG. 2C). Release setup video path control message from the Source device to release the allocated resources for the video stream. A data/control forwarding sub-table is accessed to determine forwarding of the control message and the source device sends a Terminate connection confirmation control message to the controller device. In one embodiment, the data/control forwarding sub-tables are used to determine the outbound port and lanes based on the destination address in the control messages for forwarding control messages.

In FIG. 2C, the Link control layer (i.e., Layer 2) and the PHY layer (i.e., Layer 1) are utilized wherein in an AV transmitter, Link Layer receives a Link Service Data Unit (LSDU) from higher layers and attaches a Layer 2 (i.e., RUBI L2 or LLC) header thereto, in order to construct a Link Protocol Data Unit (LPDU). The RUBI L2 header includes information such as a source address (SA) and a destination address (DA). The LPDU is a part of a PHY Service Data Unit (PSDU) and is transferred to a PHY layer in the transmitter to attach a PHY header, scrambling and encoding thereto to construct a PHY Protocol Data Unit (PPDU). The PHY header includes parameters for determining a transmission scheme including a coding/modulation scheme.

According to an embodiment of the invention, the AV transmitter PHY layer is configured to continuously transmit a fixed length of N-character data units referred to herein as Rubicles. Each Rubicle comprises a N-character data cell that may contain a combination of zero or more asynchronous and/or isochronous characters (symbols). As such, each Rubicle that is transmitted may contain no asynchronous or isochronous characters, or it may contain one or more asynchronous and/or isochronous characters.

Isochronous data is mapped onto isochronous characters and asynchronous data is mapped onto asynchronous characters in one or more Rubicles. Embodiments of the invention allow multiplexing of such asynchronous and isochronous characters for isochronous data streaming in an AV network. In one example, a PHY communication channel is represented as a continuous flow of N-character long Rubicles. The mapping of a PPDU, carrying asynchronous data, at the RUBI PHY may follow either Serial or Parallel mapping mode. According to an embodiment of the invention, the mapping of the PPDU is implemented at the PHY layer of a transmitting AV device (such utilizing a mapping module), and reconstruction of PPDU is implemented at the PHY layer of a receiving AV device (such as using a reconstruction module). Embodiments of the present invention can be implemented as one or more modules 11H in Layer 1 and/or Layer 2 in FIG. 2C.

In the Serial mapping mode, a new PPDU is mapped to Rubicles on all available lanes in a round-robin fashion, starting from the first available Rubicle on a lane. A lane that is not available is skipped. In the Parallel mode, a new PPDU is mapped to Rubicles on the next available lane such that all fragments of the PPDU are then mapped to the same lane. As such, multiple PPDUs can be served (or mapped to the Rubicles) in parallel. In the Serial mapping mode, a PPDU can not be served while the PPDU currently mapped is not completed. In either mode, a RUBI L2 header is not repeated for each PPDU.

A Rubicle is utilized for multiplexing of asynchronous and isochronous data within a single Rubicle. According to embodiments of the invention, packet-based asynchronous data is utilized, wherein a PPDU is fragmented across multiple Rubicles for transmission from an AV transmitter to an AV receiver over a communication link. Embodiments of the invention support asynchronous data transmission without increasing AV device FIFO (first-in-first-out) buffer size because multiple isochronous data streams are simultaneously multiplexed. The isochronous streams are continuously transmitted without buffering. Any unused characters in Rubicles are dynamically used for asynchronous data, which further lowers buffering at the AV transmitter. Embodiments of the invention further provide flexible multiplexing of asynchronous and isochronous data to improve the overall system efficiency, and support asynchronous data without a dedicated communication channel over the communication links.

In one embodiment, the present invention provides character (symbol)-based multiplexing wherein Rubicles are of a fixed length. As such, even in the absence of any asynchronous or isochronous data, packets are continuously transmitted. Said RUBI L2 header is only used in the very first PPDU fragment, and subsequent PPDU fragments do not carry the RUBI L2 header. One MSDU is fragmented across multiple PPDUs without the need for indication bits in the PPDU or MPDU.

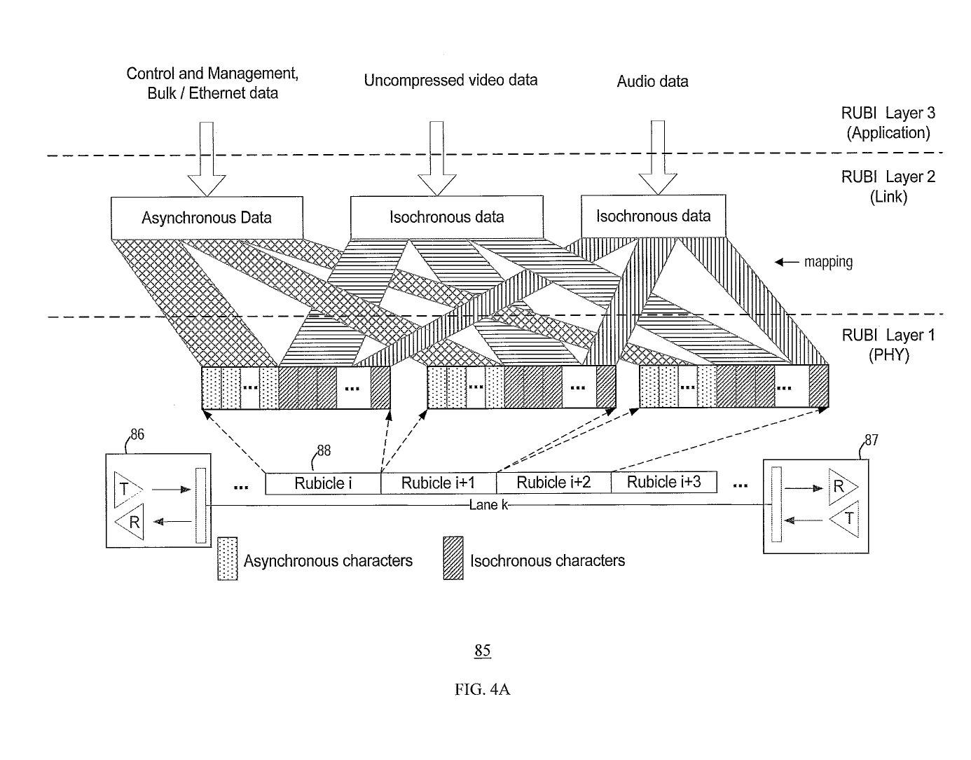

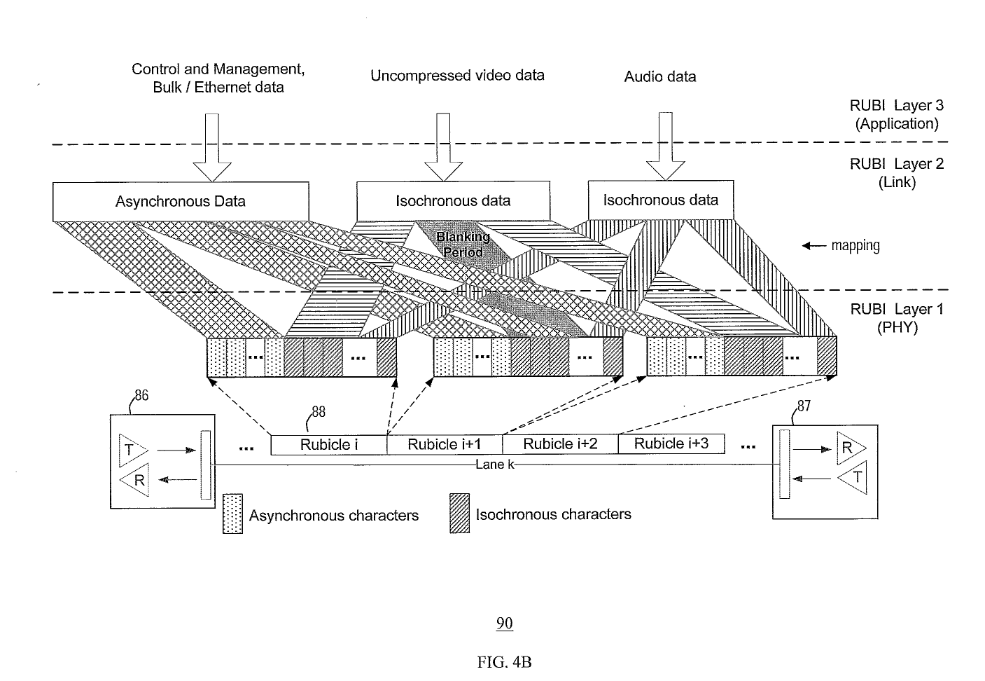

FIG. 4A illustrates a process 85 for multiplexing of asynchronous and isochronous data between AV devices such as an AV transmitter 86 and an AV receiver 87 (in an AV network such as network 20 in FIG. 1C), according to an embodiment of the invention. Management and control data pertaining to the link layer (Layer 2 or L2) and an application layer (Layer 7 or L7) are also multiplexed with AV data. A communication lane (e.g., lane k) that is configured for the data flow direction to be in the Transmit mode, continuously transmits a fixed length of N-character units a Rubicle 88.

Each Rubicle 88 comprises a data cell including zero or more asynchronous and isochronous characters. In each Rubicle 88, isochronous data is mapped onto isochronous characters and asynchronous data is mapped onto asynchronous characters, as shown in FIG. 4A. Each character carries a fixed amount of data. In one embodiment of the invention, one character may carry 10-bit if 8b/10b coding is used. Isochronous data is mapped onto isochronous characters and asynchronous data is mapped onto asynchronous characters. Rubicles 88 are continuously transmitted irrespective of presence or absence of isochronous or asynchronous data therein.

In one embodiment, isochronous data is reserved using a stream/path set-up scheme. Therefore, in a Rubicle 88 reserved characters belong to isochronous data or stream. As shown in FIG. 4A, reserved characters in a Rubicle are mapped to isochronous data belonging to uncompressed video and audio data. Such isochronous data may belong to multiple sources and multiple destinations thus allowing multiplexing of multiple isochronous streams within a single Rubicle 88. Within a Rubicle 88, the unreserved characters may be mapped to asynchronous data as shown in FIG. 4A.

In one implementation, asynchronous data and isochronous data (e.g., generated by application layer or transport layer) are mapped to the fixed length Rubicles 88. The location of isochronous characters in a Rubicle 88 is determined by accessing an isochronous forwarding table 11E (e.g., stored in Layer 2) that indicates reserved characters for isochronous streams. Asynchronous characters are unreserved characters in a Rubicle 88 onto which asynchronous data is mapped. In one implementation, all unreserved characters (asynchronous characters) and all reserved characters (isochronous characters) in a Rubicle 88 can be sub-grouped such that the asynchronous characters appear first followed by the isochronous characters.

### Isochronous Data Mapping

In one embodiment, the invention provides asynchronous data transmission during reserved isochronous characters when the reserved characters do not carry any useful AV data during video blanking periods. Embodiments of the invention allow mapping of asynchronous data over reserved isochronous characters. Video data transmission occurs during a reserved isochronous period. The isochronous period includes active video pixel period in addition to video blanking periods. As asynchronous data is multiplexed with isochronous data on the same lane, embodiments of the invention use the blanking periods for transmitting useful data such as asynchronous data.

According to an embodiment of the invention disclosed herein, video data is transmitted via isochronous characters of each Rubicle, between AV devices 11. In one example, such video data comprises video frame 9 as shown in FIG. 3. Each such video frame 9 corresponds to one frame in a progressive mode and one field in an interlaced mode. Instead of Vertical Synchronization (VSYNC) and Horizontal Synchronization (HSYNC), control sequences (i.e., SoB and SoL Sequence) are used to indicate video timing. In one example, a blanking period comprises a vertical blanking interval, also known as the vertical interval, which is a time difference between the last line of one frame or field of a raster display, and the beginning of the first line of the next frame. Vertical blanking period (i.e., vertical blanking interval) and horizontal blanking period (i.e., horizontal blanking interval) are well known.

In one embodiment, the following control sequences are used for transmission of video data (e.g., video frame 9):
SoB: Start of Blanking Period
SoL: Start of Active Video Lane
SoI: Start of Info Packet
SoAP: Start of Asynchronous Packet
EoAP: End of Asynchronous Packet
BoD: Blank out Data. This control sequence is transmitted during the blanking period

Said control sequences can be repeated multiple times on each active lane 13 in a given direction to enhance robustness. As shown in FIG. 3, each Info frame is preceded by a SoI control character followed by Info frame type, info frame payload (e.g., RUBI Auxiliary Video Info) and the CRC field. The Info frame types are audio and video. For example, a RUBI Video Info (RVI) frame such as frame 9 is transmitted once per video frame during video blanking period. The fields of the video Info frame comprise:
Scrambler: 2-bits
   00: Intra-line
   01: Inter-line
   10: None
   11: Reserved
Frame Field: 2-bits
   00=Frame in the progressive mode
   01=Field1 in the interlaced mode
   10=Field2 in the interlaced mode
   11=Reserved
Mute: 1-bit
   When set, the display should be muted
Picture Aspect Ratio: 2-bit
   00: 4:3
   01: 16:9
   10 & 11: Reserved
3D/2D: 1-bit
   Indicate the video is 2D or 3D
Video field: 2-bits
Video frame sequence number: 8-bits
   Frame number as a modulo of 256
   The same value of the video frame sequence is used in the Audio frame
Gamut Flag: 2-bits
   00: the current frame follows the previously transmitted gamut metadata
   01: the current frame follows the previously transmitted gamut metadata and the frame indicated by the Effected Frame follows the updated gamut data
   10: New gamut value effected from this frame
   11: Current frame does not require any gamut data
Effected Frame: 4-bits
   The frame number of the effected frame which is affected by the new gamut metadata. The effected frame is calculated by adding the value in the Effected Frame to the Video frame sequence number field. When the Gamut flag is set to 10, the Effected Frame is zero.
Video Format
   The video format field is 1-byte long indicating the video format as RGB, YCbCr, xvYCC, etc.

In one embodiment of the invention, active video pixels in a video line (e.g., HL0) of the AV frame 9 are started by transmitting a SoL control sequence followed by 1-byte lane header (i.e., LH) representing horizontal lanes as modulo of 256. This field is set to 0 for the first active horizontal lane of a video frame. A video blanking period (e.g., Horizontal Blank, Vertical Blank) can also be used for transmitting an asynchronous packet.

In one embodiment, the invention further provides flexibility in transmitting asynchronous packet between two AV devices that are different from the devices the isochronous characters are reserved for. The asynchronous data packet includes source and destination address fields based on which asynchronous data packet is switched at each hop by accessing the forwarding/switching table at the receiving device. The blanking period can also be used for transmission of audio data to the same device that the video is being transmitted to or to a different audio sink device.

### Asynchronous Data Transmission in Non-Active Isochronous Video Characters

According to an embodiment of the invention, a device that has reserved isochronous characters for video, transmits special control characters during a video blanking period to indicate the presence of a video blanking period. This provides flexibility such that any device on the path from the source device to the sink device can fill a video blanking period with useful data. This is not limited to the pair of devices the isochronous characters are originally reserved for.

According to an embodiment of the invention, in general there are two cases when the video blanking period can be used for asynchronous data transfer. In the first case, asynchronous data being transmitted over asynchronous characters is extended over isochronous characters. In the second case, the source device that reserved the isochronous characters can fill the video blanking period by transmitting asynchronous data.

FIG. 3 illustrates an example of the first case wherein the source device sends asynchronous data during a video blanking period. The source device inserts Start of Asynchronous Packet (SoAP) and End of Asynchronous Packet (EoAP) characters before and after the asynchronous packet (Asynchronous Data), respectively. Since the video blanking period is not indicated by the presence of the blanking characters, the video blanking period can be used by other devices.

FIG. 4B illustrates an example process 90 for the second case wherein asynchronous data is extended and mapped over isochronous characters which are currently carrying blanking data. FIG. 4B shows use of non-active (blanking) video isochronous characters for asynchronous data transmission. In this case one-hop receiving device utilizes signaling to learn whether the asynchronous data is being extended over isochronous characters or not. In one embodiment, a APOB (Asynchronous Packet Over Blanking) control character is transmitted preceded by an identifier of the first isochronous character, out of a group of isochronous characters reserved for a particular stream, over which the asynchronous characters would be extended.

Generally, an isochronous reservation table includes information about which characters are currently reserved for which isochronous streams. In one embodiment, the isochronous character identifier can carry the index of the first character of a series of characters reserved for a particular isochronous stream in a Rubicle. In another embodiment, this field can be replaced with the stream index since the purpose is to mainly indicate to the receiver which isochronous characters are used. Thereafter, the asynchronous data is mapped over isochronous characters.

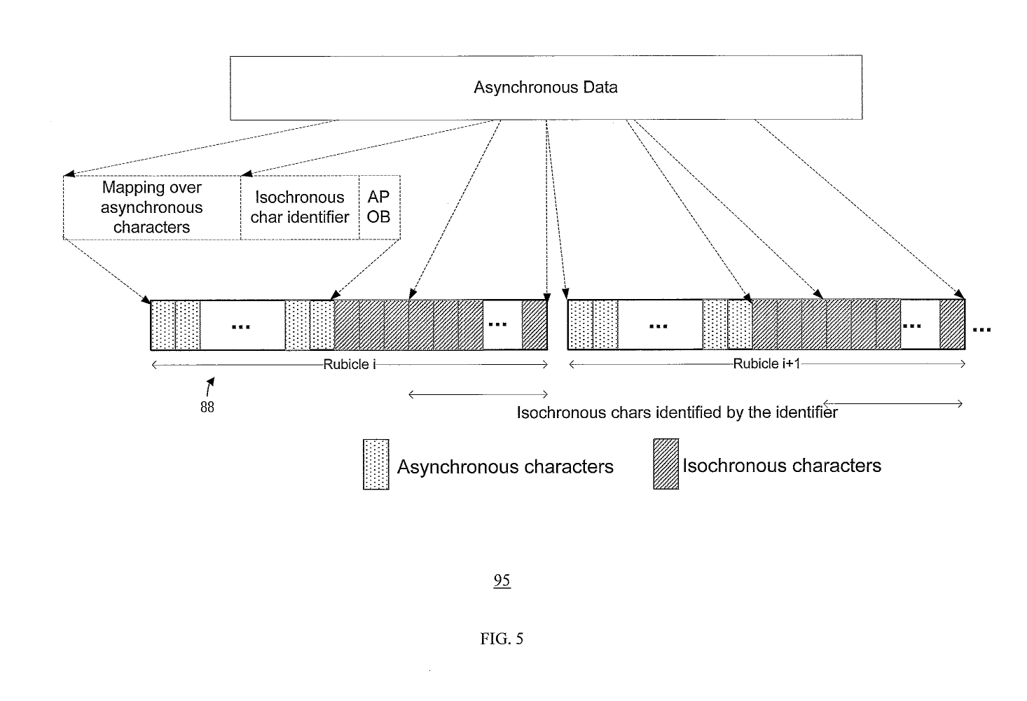

In one implementation of the invention, once the mapping of asynchronous data over isochronous characters is established, the mapping remains effective until explicitly released by the source device. In one embodiment, when two APOB are present as the last two characters of the asynchronous characters, the mapping is terminated. In order to reduce the complexity of the scheme, if the entire allocation of isochronous characters in a Rubicle is not filled with blanking control characters then asynchronous data is not extended. FIG. 5 illustrates an example process 95 wherein asynchronous data is extended over the isochronous characters currently carrying the video blanking data, according to an embodiment of the invention. FIG. 5 illustrates a process at the transmitter side (source). The receiver side (e.g., sink) upon detecting the APOB, extracts asynchronous data from the isochronous characters identified by the isochronous character identifier.

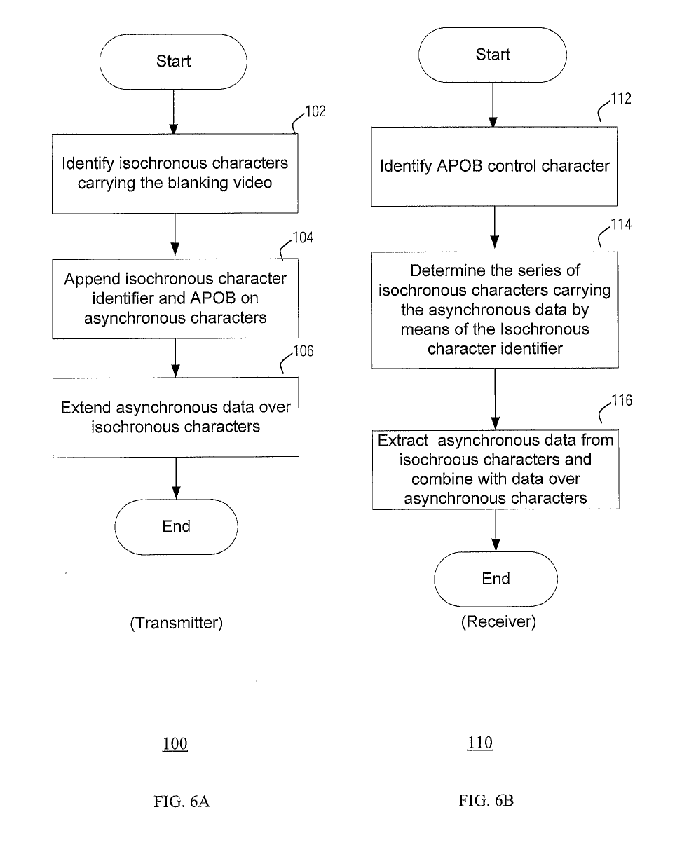

FIGS. 6A-6B illustrate flowcharts of process blocks for said second case for transmitter and receiver operations, respectively, according to an embodiment of the invention. Referring to process 100 in FIG. 6A for a transmitter (e.g., an AV source device 11), process block 102 comprises identifying isochronous characters carrying the blanking video, process block 104 comprises appending an isochronous character identifier and APOB on asynchronous characters, and process block 106 comprises extending asynchronous data over isochronous characters, as described. Referring to process 110 in FIG. 6B for a receiver (e.g., an AV sink device 11), process block 112 comprises identifying APOB control character in a received packet, process block 114 comprises determining the series of isochronous characters carrying the asynchronous data using the Isochronous character identifier, and process block 116 comprises extracting asynchronous data from isochronous characters and combining with data over asynchronous characters.

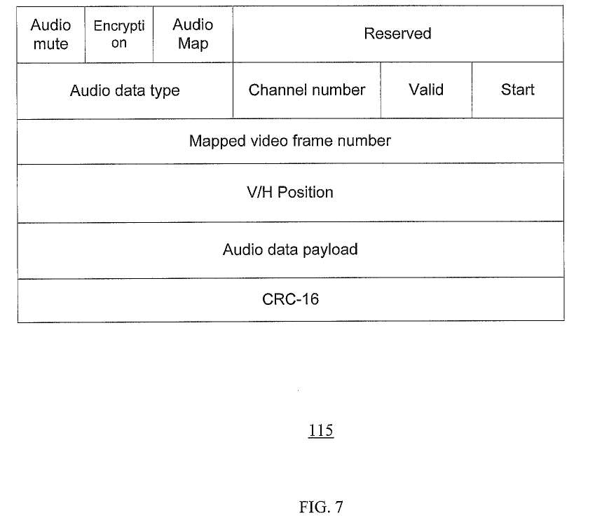

According to an embodiment of the invention, the blanking period may also be used for sending audio data packets. An audio packet is preceded by SoAU (Start of Audio) control character and followed by EoAU (End of Audio) control character, as shown by an example Audio packet/frame 115 in FIG. 7. An Audio mute field is one bit in length and if set the audio will be muted. An Encryption type field is 2 bits in length, with the following possible values:
a. 0x0=not encrypted
b. 0x1=HDCP2.0
c. 0x2-0x3=reserved

An Audio map field is one bit in length and if set the audio has a corresponding video to which the audio needs to be synchronized. In this case a Mapped video frame number and the vertical/horizontal (V/H) position fields would be valid. The valid values for the Audio data type field are defined as follows:
d. 0x0=IEC 60958-1
e. 0x1=DSD
f. 0x2=DST
g. 0x3=DST with double rate
h. 0x4=One bit audio
i. 0x5-0x7=reserved

The valid values for a Channel number field are as follows:
j. 0x0=Data0 is for channel0 and Data1 is for channel1
k. 0x1=Data0 is for channel2 and Data1 is for channel3
l. 0x2=Data0 is for channel4 and Data1 is for channel5
n. 0x7=Data0 is for channel14 and Data1 is for channel15

The value of a Valid field is set to 0 if the Audio data payload does not contain valid data. A Start field is interpreted based on the Audio data type field. If the Audio data type field is set to 0x01, then the Start bit is set to one if the Audio data payload contains the first frame in a 192 frame IEC60958 Channel Status Block. If the Audio data type field is set to 0x02, then the Start bit is set to zero. If the Audio data type field is set to 0x03 or 0x04, then the Start is set to one at every Direct Stream Transfer (DST) frame start. If the audio data type field is set to 0x04, then the Start bit is set to zero. The mapped video frame number carries the same number as the video frame sequence number. The V/H position field is set to the vertical and horizontal pixel number to which the first byte of the audio data corresponds to. The Audio data payload is formatted based on the Audio data type field.

As such, according to embodiments of the invention, a frame structure is used for data transmission between a source device 11 and a sink device 11 (e.g., FIG. 1B). A Link Layer Control (LLC) layer and a physical (PHY) layer are utilized. wherein in a transmitter, a LLC receives a Link Service Data Unit (LSDU) and attaches a RUBI Layer 2 (L2) header thereto, in order to construct a Link Protocol Data Unit (LPDU). The RUBI L2 header includes information such as a source address (SA) and a destination address (DA). The LPDU is a part of a PHY Service Data Unit (PSDU) and is transferred to a PHY layer in the transmitter to attach a PHY header, scrambling and encoding thereto to construct a PHY Protocol Data Unit (PPDU). The PHY header includes parameters for determining a transmission scheme including a coding/modulation scheme.

In one embodiment of the invention, as noted each RUBI device X, Y in a wired network comprises a LLC layer, PHY layer, hardware processor, memory, logic and transceiver configured for communication over a wired network, according to embodiments of the invention. Media Access Control (MAC) is the data communication protocol sub-layer of the Data Link Layer (DLL) in the seven-layer Open Systems Interconnection (OSI) model. Other wired RUBI devices may be included in the network.

In one embodiment, the PHY layer is configured to continuously transmit a fixed length of N-character units (i.e., Rubicles), which is a combination of zero or more asynchronous and isochronous characters. Isochronous data is mapped onto isochronous characters and asynchronous data is mapped onto asynchronous characters. This allows multiplexing of asynchronous and isochronous characters. A PHY channel is represented as a continuous flow of N-character long Rubicles. The Rubicle includes a combination of asynchronous and isochronous characters. Isochronous stream data is mapped onto isochronous characters in Rubicles.

Asynchronous data is mapped onto asynchronous characters on one or more Rubicles. The mapping of a PPDU, carrying asynchronous data, at the RUBI PHY may follow either Serial or Parallel mapping mode. In the Serial mode, a new PPDU is mapped to Rubicles on all available lanes in the round-robin way, starting from the first available Rubicle on a Lane. A lane that is not available is skipped for the mapping. In the Parallel mode, a new PPDU is mapped to Rubicles on the next available lane such that all fragments of the PPDU are then mapped to the same lane. In this way multiple PPDUs can be served (or mapped to the Rubicles) in parallel. However, in the serial mapping case, a PPDU can not be served while the PPDU currently mapped is not finished. In either of the schemes, the RUBI L2 header is not repeated for each PPDU.

Accordingly, embodiments of the invention provide flexible multiplexing of asynchronous and isochronous data to improve the overall system efficiency. In one embodiment, considering 1920x1080 frame, there is about 33% blanking period of a total frame (2750x1125) such as frame 9. Assuming that 50% of the blanking period is used for video related control data, there are unused isochronous characters left, of which 16% can be used for transmitting asynchronous data. Embodiments of the invention support high data rate and low latency asynchronous data without requiring a dedicated communication channel. Embodiments of the invention provide transmission of asynchronous data when no asynchronous characters are available.

As is known to those skilled in the art, the aforementioned example architectures described above, according to the present invention, can be implemented in many ways, such as program instructions for execution by a processor, as software modules, microcode, as computer program product on computer readable media, as logic circuits, as application specific integrated circuits, as firmware, as consumer electronic devices, etc., in devices, in transmitters, receivers, transceivers in networks, etc. Further, embodiments of the invention can take the form of an entirely hardware embodiment, an entirely software embodiment or an embodiment containing both hardware and software elements.

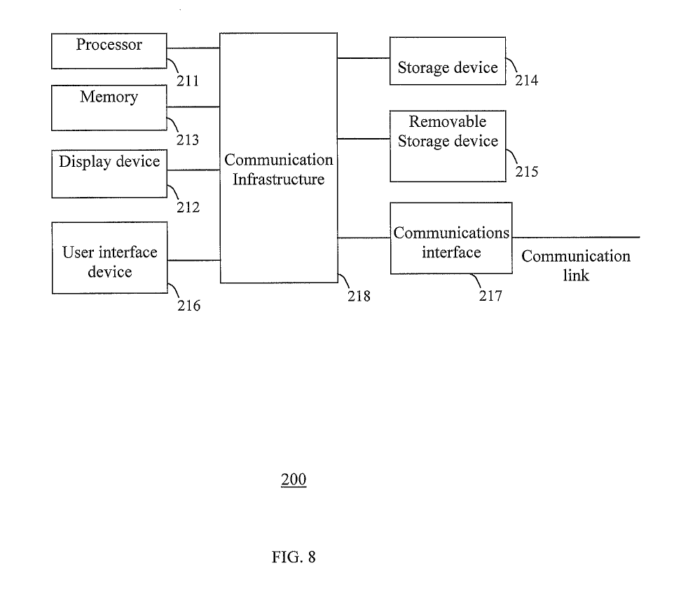

FIG. 8 is a high level block diagram showing an information processing system comprising a computer system 200 useful for implementing an embodiment of the present invention. The computer system 200 includes one or more processors 211, and can further include an electronic display device 212 (for displaying graphics, text, and other data), a main memory 213 (e.g., random access memory (RAM)), storage device 214 (e.g., hard disk drive), removable storage device 215 (e.g., removable storage drive, removable memory module, a magnetic tape drive, optical disk drive, computer readable medium having stored therein computer software and/or data), user interface device 216 (e.g., keyboard, touch screen, keypad, pointing device), and a communication interface 217 (e.g., modem, a network interface (such as an Ethernet card), a communications port, or a PCMCIA slot and card). The communication interface 217 allows software and data to be transferred between the computer system and external devices. The system 200 further includes a communications infrastructure 218 (e.g., a communications bus, cross-over bar, or network) to which the aforementioned devices/modules 211 through 217 are connected.

Information transferred via communications interface 217 may be in the form of signals such as electronic, electromagnetic, optical, or other signals capable of being received by communications interface 217, via a communication link that carries signals and may be implemented using wire or cable, fiber optics, a phone line, a cellular phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments of the present invention have been described with reference to flowchart illustrations and/or block diagrams of methods, apparatus (systems) and computer program products according to embodiments of the invention. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic, implementing embodiments of the present invention. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer programs (i.e., computer control logic) are stored in main memory and/or secondary memory. Computer programs may also be received via a communications interface. Such computer programs, when executed, enable the computer system to perform the features of the present invention as discussed herein. In particular, the computer programs, when executed, enable the processor and/or multi-core processor to perform the features of the computer system. Such computer programs represent controllers of the computer system.

Though the present invention has been described with reference to certain versions thereof; however, other versions are possible. Therefore, the spirit and scope of the appended claims should not be limited to the description of the preferred versions contained herein.

What is claimed is:

1. A method of communication between audio/video (AV) devices, comprising:
establishing an AV path stream for AV data streaming between a source AV device and a destination AV device, wherein each AV device includes one or more I/O ports for connecting the AV device to another AV device via a communication link including multiple communication lanes;
multiplexing asynchronous and isochronous AV data for transmission via one or more fixed length data cells, each data cell capable of carrying one or more of: an asynchronous data symbol and an isochronous data symbol;
wherein multiplexing includes selectively mapping asynchronous data onto isochronous symbols for transmission during a video blanking period; and
transmitting one or more data cells from a physical layer of the source AV device to the destination AV device, via one or more communication lanes.

2. The method of claim 1, wherein:
multiplexing further includes mapping isochronous data onto isochronous symbols in one or more data cells, mapping asynchronous data onto asynchronous symbols in one or more data cells, and selectively mapping asynchronous data onto reserved isochronous symbols; and
asynchronous data is transmitted during reserved isochronous symbols when the reserved symbols do not carry useful data during a video blanking period.

3. The method of claim 2, further comprising:
multiplexing multiple isochronous data streams by mapping the data streams into multiple data cells; and
continually transmitting the isochronous streams via the data cells from the source AV device to the destination AV device on one or more communication lanes.

4. The method of claim 3, wherein:
multiplexing further comprises dynamically mapping asynchronous data into available symbols in the data cells for transmission from the source AV device to the destination AV device on one or more communication lanes.

5. The method of claim 2, wherein:
transmitting further comprises, during an isochronous blanking period, transmitting asynchronous data between AV devices which are different from AV devices that reserved the isochronous symbols.

6. The method of claim 2, wherein:
in a switched network comprising said AV source device and said AV sink device serially connected via intermediate AV devices via said communication links, one or more of said intermediate devices utilizing said isochronous symbols.

7. The method of claim 2, further comprising:
transmitting asynchronous data during a video blanking period, such that asynchronous data transmitted over asynchronous symbols is extended into isochronous symbols.

8. The method of claim 2, further comprising:
the AV source device reserving isochronous symbols, and using the video blanking period for transmitting asynchronous data in isochronous symbols.

9. The method of claim 2, further comprising:
the AV source device generating a packet by identifying isochronous symbols for the video blanking period;
appending an isochronous symbol identifier and blanking period packet identifier for isochronous symbols; and
extending asynchronous data into isochronous symbols for packet transmission to the AV sink device.

10. The method of claim 2, further comprising:
the AV sink device identifying blanking period packet identifier in a received packet;
determining isochronous symbols carrying asynchronous data based on the isochronous symbol identifier; and
extracting asynchronous data from isochronous symbols and combining with data from asynchronous symbols.

11. The method of claim 2, further comprising:
transmitting audio data during a blanking period, wherein an audio frame is preceded by a start of audio indication and followed by an end of audio indication.

12. An audio/video (AV) streaming system, comprising:
a switched network of AV devices serially connected via communication links;
wherein at least one of said AV devices comprises:
a connection setup module that establishes an AV path stream for AV data streaming between a source AV device and a destination AV device, wherein each AV device includes one or more I/O ports for connecting the AV device to another AV device via a communication link including multiple communication lanes; and
a mapping module that multiplexes asynchronous and isochronous AV data for transmission via one or more fixed length data cells at a physical (PHY) layer configured for communicating one or more data cells from the source AV device to the destination AV device via one or more communication lanes, wherein each data cell capable of carrying one or more of: asynchronous data symbols and isochronous data symbols;
wherein the mapping module multiplexes asynchronous and isochronous AV data for transmission via one or more fixed length data cells, such that multiplexing includes selectively mapping asynchronous data onto isochronous symbols for transmission during a video blanking period.

13. The system of claim 12, wherein:
the mapping module maps isochronous data onto isochronous symbols in one or more data cells, mapping asynchronous data onto asynchronous symbols in one or more data cells, and selectively mapping asynchronous data onto reserved isochronous symbols, such that asynchronous data is transmitted during reserved isochronous symbols when the reserved symbols do not carry useful data during a video blanking period.

14. The system of claim 13, wherein:
the mapping module multiplexes multiple isochronous data streams by mapping the data streams into multiple data cells; and
the PHY layer continually transmitting the isochronous streams via the data cells from the source AV device to the destination AV device on one or more communication lanes.

15. The system of claim 14, wherein:
the mapping module dynamically maps asynchronous data into available symbols in the data cells for transmission from the source AV device to the destination AV device on one or more communication lanes.

16. The system of claim 13, wherein:
during an isochronous blanking period, asynchronous data is transmitted between AV devices which are different from AV devices that reserved the isochronous symbols.

17. The system of claim 13, wherein:
in a switched network comprising said AV source device and said AV sink device serially connected via intermediate AV devices via said communication links, one or more of said intermediate devices utilizing said isochronous symbols.

18. The system of claim 13, wherein during video blanking period asynchronous data is transmitted over asynchronous symbols by extending into isochronous symbols.

19. The system of claim 13, wherein:
the AV source device reserves isochronous symbols, and uses the video blanking period for transmitting asynchronous data in isochronous symbols.

20. The system of claim 13, wherein:
the AV source device generates a packet by identifying isochronous symbols for video blanking period, appends an isochronous symbol identifier and blanking period packet identifier for isochronous symbols, and extends asynchronous data into isochronous symbols for packet transmission to the AV sink device.

21. The system of claim 13, wherein:
the AV sink device identifies blanking period packet identifier in a received packet, determines isochronous symbols carrying asynchronous data based on the isochronous symbol identifier, extracts asynchronous data from isochronous symbols and combining with data from asynchronous symbols.

22. The system of claim 12, wherein:
the AV source device transmits audio data during a blanking period, wherein an audio frame is preceded by a start of audio indication and followed by an end of audio indication.

23. An audio/video (AV) device, comprising:
a connection setup module that establishes an AV path stream for AV data streaming between a source AV device and a destination AV device, wherein each AV device includes one or more I/O ports for connecting the AV device to another AV device via a communication link including multiple communication lanes; and
a mapping module that multiplexes asynchronous and isochronous AV data for transmission via one or more fixed length data cells at a physical (PHY) layer configured for communicating one or more data cells from the source AV device to the destination AV device via one or more communication lanes, wherein each data cell capable of carrying one or more of: asynchronous data symbols and isochronous data symbols;
wherein the mapping module multiplexes asynchronous and isochronous AV data for transmission via one or more fixed length data cells, such that multiplexing includes selectively mapping asynchronous data onto isochronous symbols for transmission during a video blanking period, between the source AV device and the destination AV device in a switched network of AV devices.

24. The AV device of claim 23, wherein:
the mapping module maps isochronous data onto isochronous symbols in one or more data cells, mapping asynchronous data onto asynchronous symbols in one or more data cells, and selectively mapping asynchronous data onto reserved isochronous symbols, such that asynchronous data is transmitted during reserved isochronous symbols when the reserved symbols do not carry useful data during a video blanking period.

25. The AV device of claim 23, wherein:
the mapping module multiplexes multiple isochronous data streams by mapping the data streams into multiple data cells; and
the PHY layer continually transmitting the isochronous streams via the data cells from the source AV device to the destination AV device on one or more communication lanes.

26. The AV device of claim 25, wherein:
the mapping module dynamically maps asynchronous data into available symbols in the data cells for transmission from the source AV device to the destination AV device on one or more communication lanes.

27. The AV device of claim 24, wherein:
during an isochronous blanking period, asynchronous data is transmitted between AV devices which are different from AV devices that reserved the isochronous symbols.

28. The AV device of claim 24, wherein:
in a switched network comprising said AV source device and said AV sink device serially connected via intermediate AV devices via said communication links, one or more of said intermediate devices utilizing said isochronous symbols.

29. The AV device of claim 24, wherein
during video blanking period asynchronous data is transmitted over asynchronous symbols by extending into isochronous symbols.

30. The AV device of claim 24, wherein:
the AV source device reserves isochronous symbols, and uses the video blanking period for transmitting asynchronous data in isochronous symbols.

31. The AV device of claim 24, wherein:
the AV device functioning as the AV source device generates a packet by identifying isochronous symbols for video blanking period, appends an isochronous symbol identifier and blanking period packet identifier for isochronous symbols, and extends asynchronous data into isochronous symbols for packet transmission to the AV sink device.

32. The AV device of claim 24, wherein:
the AV device functioning as the AV sink device identifies blanking period packet identifier in a received packet, determines isochronous symbols carrying asynchronous data based on the isochronous symbol identifier, extracts asynchronous data from isochronous symbols and combining with data from asynchronous symbols.

33. The AV device of claim 23, wherein:
the AV source device transmits audio data during a blanking period, wherein an audio frame is preceded by a start of audio indication and followed by an end of audio indication.
